(19) United States
(12) Patent Application Publication
(10) Pub. No.: US 2026/0116186 A1
(43) Pub. Date: Apr. 30, 2026

(54) HEADS UP DISPLAY WITH INERTIAL MEASUREMENT CORRECTION FOR ACCURATE EYE TRACKING

(71) Applicant: FCA US LLC, Auburn Hills, MI (US)

(72) Inventors: Michael A.M. Bork, Auburn Hills, MI (US); Matthieu Donain, Poissy (FR)

(21) Appl. No.: 18/932,697

(22) Filed: Oct. 31, 2024

(51) Int. Cl. B60K 35/235; B60K 35/65; B60K 35/81; B60R 16/023; G06F 3/01; G06T 5/20; G06T 5/70; G06T 7/70; G06T 11/00; G09G 3/00

(52) U.S. Cl. CPC B60K 35/235; B60K 35/654; B60K 35/81; G06F 3/013; G06T 5/20; G06T 5/70; G06T 7/70; G06T 11/00; G09G 3/001; B60K 2360/177; B60K 2360/21; B60R 16/0231; G06T 2207/10048; G06T 2207/20084; G06T 2207/30201; G06T 2207/30268; G09G 2354/00; G09G 2380/10

(57) ABSTRACT

A heads-up display (HUD) system for a vehicle includes a HUD configured to project augmented reality (AR) graphics on a surface of the vehicle in an active field of view of the driver, a driver monitoring camera (DMC) configured to monitor a driver eye position and gaze direction, and an inertial measurement unit (IMU) configured to measure motion of the vehicle. A control system is configured to receive driver eye position and gaze direction data from the DMC, receive vehicle motion data from the IMU, generate AR HUD graphics based on the driver eye position and gaze direction data and the vehicle motion data, and display, by the HUD, the generated AR HUD graphics on the vehicle surface.

### FIELD

The present application relates generally automotive heads-up display (HUD) systems and, more particularly, to automotive HUD systems with accurate eye position for augmented reality.

### BACKGROUND

In automotive applications, a heads-up display (HUD) system includes a portion of a front windshield that is treated or processed in such a way that a projected image will reflect back to a driver of the automobile. HUDs may be enhanced by augmented reality (AR) to interact with moving objects near the vehicle to promote user awareness. However, high system latency may cause the moving objects to be sensed, registered, rendered, and displayed too slowly. As a result, the content may potentially not align with the intended real-world space, which can cause user distraction. Accordingly, while conventional systems work well for their intended purpose, there exists an opportunity for improvement in the relevant art.

### SUMMARY

In one example aspect of the invention, a heads-up display (HUD) system for a vehicle is provided. In one example implementation, the HUD system includes a HUD configured to project augmented reality (AR) graphics on a surface of the vehicle in an active field of view of the driver, a driver monitoring camera (DMC) configured to monitor a driver eye position and gaze direction, and an inertial measurement unit (IMU) configured to measure motion of the vehicle. A control system includes a computing device having one or more processors and a non-transitory computer-readable storage medium having a plurality of instructions stored thereon, which, when executed by the one or more processors, cause the one or more processors to perform the following operations: receiving driver eye position and gaze direction data from the DMC, receiving vehicle motion data from the IMU, generating AR HUD graphics based on the driver eye position and gaze direction data and the vehicle motion data, and displaying, by the HUD, the generated AR HUD graphics on the vehicle surface.

In addition to the foregoing, the described HUD system may include one or more of the following features: wherein the generated AR HUD graphics provide real-time corrections to AR HUD graphics based on real-time vehicle movement, driver head movement, and driver eye movement such that the displayed AR HUD graphics are accurately displayed in an intended position with respect to the driver's perspective of a real-world scene; wherein the vehicle motion measured by the IMU includes axial and angular accelerations of the vehicle; and a low voltage differential signal (LVDS) connection between the DMC and the control system.

In addition to the foregoing, the described HUD system may include one or more of the following features: a CAN bus connection between the IMU and the control system, wherein data from the IMU is received at a frequency no slower than 30 Hz; wherein data from the IMU is received at a frequency no slower than 100 Hz; wherein the control system processes data from the DMC using Convolutional Neural Networks (CNNs) and/or Recurrent Neural Networks (RNNs); wherein the control system further processes data from the DMC utilizing Kalman filters to smooth noisy image data and predict an accurate eye gaze position; wherein the surface is a windshield of the vehicle; and wherein the DMC is infrared (IR) based.

In accordance with another example aspect of the invention, a computer-implemented method is provided for controlling a vehicle heads-up display (HUD) system having a HUD configured to project augmented reality (AR) graphics on a surface of the vehicle in an active field of view of the driver, a driver monitoring camera (DMC) configured to monitor a driver eye position and gaze direction, and an inertial measurement unit (IMU) configured to measure motion of the vehicle. The method includes receiving, at a computing device having one or more processors, driver eye position and gaze direction data from the DMC; receiving, at the computing device, vehicle motion data from the IMU; generating, by the computing device, AR HUD graphics based on the driver eye position and gaze direction data and the vehicle motion data; and displaying, by the HUD, the generated AR HUD graphics on the vehicle surface.

In addition to the foregoing, the described method may include one or more of the following features: wherein the generated AR HUD graphics provide real-time corrections to AR HUD graphics based on real-time vehicle movement, driver head movement, and driver eye movement such that the displayed AR HUD graphics are accurately displayed in an intended position with respect to the driver's perspective of a real-world scene; wherein the vehicle motion measured by the IMU includes axial and angular accelerations of the vehicle; and wherein the HUD system further includes a low voltage differential signal (LVDS) connection between the DMC and the control system.

In addition to the foregoing, the described method may include one or more of the following features: wherein the HUD system further includes a CAN bus connection between the IMU and the control system, wherein data from the IMU is received at a frequency no slower than 30 Hz; wherein data from the IMU is received at a frequency no slower than 100 Hz; processing, by the computing device, data from the DMC using Convolutional Neural Networks (CNNs) and/or Recurrent Neural Networks (RNNs); processing, by the computing device, data from the DMC using Kalman filters to smooth noisy image data and predict an accurate eye gaze position; wherein the surface is a windshield of the vehicle; and wherein the DMC is infrared (IR) based.

Further areas of applicability of the teachings of the present application will become apparent from the detailed description, claims and the drawings. It should be understood that the detailed description, including disclosed embodiments and drawings referenced therein, are merely exemplary in nature intended for purposes of illustration only and are not intended to limit the scope of the present application, its application or uses. Thus, variations that do not depart from the gist of the present application are intended to be within the scope of the present application.

### BRIEF DESCRIPTION OF DRAWINGS

FIG. 1 is a functional block diagram of a vehicle having an example heads-up display (HUD) system in accordance with the principles of the present disclosure;

FIG. 2 is a functional block diagram of an example architecture of the HUD system shown in FIG. 1, in accordance with the principles of the present disclosure; and

FIG. 3 is a flow diagram of an example method of operating the HUD system shown in FIGS. 1 and 2, in accordance with the principles of the present disclosure.

### DESCRIPTION

As previously discussed, conventional automotive heads-up display (HUD) technologies may have high system latency. The HUD may incorporate augmented reality (AR), which is a view of a physical real-world environment combined with computer-generated sensor input. AR HUD graphics intended to interact with moving objects near the vehicle are sensed, registered, rendered and then displayed too slowly due to latency, the content may not align with the intended real-world space and cause user distraction. Moreover, for HUD technologies that require very specific location information for either one or both eyes, current compensation may not be sufficient to enable an AR HUD-based experience. Rapid changes in the driver eye position, such as those introduced by a bumpy roadway, may cause a misalignment between the virtual image perspective and its intended placement in the real world.

Accordingly, the present application is generally directed to a vehicle AR HUD system that utilizes a combination of vehicle sensors to provide a highly accurate eye position regardless of motions induced by the ego-vehicle (vehicle motion) or the roadway on which it is traveling. As a result, this accurate eye position information can be used to enable an AR HUD-based experience with HUD technologies that require precise cyclopean or stereo eye position information.

In one example, an onboard inertial measurement unit (IMU) measures the axial and angular accelerations and changes of the ego-vehicle. The output data from the IMU is sent to the head unit (HU), via CAN bus communication, for further calculation. The IMU data can be fused with the intrinsic vehicle information in a dedicated electronics control unit (ECU) and then sent to the HUD at a frequency of no slower than, for example, 30 Hz. Alternatively, the raw output information from the IMU can also be sent directly to the HU for fusion, to accommodate for the calculation time. This may be sent at a frequency no slow than, for example, 100 Hz.

A driver monitoring camera (DMC) is utilized to observe, record, and transmit specific user-related features such as eye position, gaze direction/vector, etc. The DMC may be RGB or IR-based, though IR-based may be preferred due to its superior performance in low-light conditions. The video frame data from the DMC is sent to the HU via a low voltage differential signal (LVDS) connection. The serializer-deserializer communication protocol can be, for example, FPDLink, GMSL, or other.

The DMC data is utilized for HUD applications where it is necessary to mitigate the parallax effect by aligning the HUD content with its intended location in the real world. In other words, the DMC is required to make sure the HUD graphics are accurately placed for the user's perspective. The sent video frame data can be processed through a deterministic model to determine accurate gaze and eye position information. Example algorithms to accomplish this include Convolutional Neural Networks (CNNs) and Recurrent Neural Networks (RNNs).

CNNs and RNNs can be used to process the sequential image data that is output by the DMC and calculate eye gaze information and patterns. Additionally, Kalman filters may be implemented as part of the algorithm, which are statistical algorithms that estimate the state of a system over time. In the context of eye tracking, the Kalman filters can smooth noisy image data to predict an accurate eye gaze position. Once the eye positions are generated, the perspective-corrected images can then be generated and sent to the HUD for projection. In some examples, this process can take hundreds of milliseconds and can result in an image that appears to lag behind its intended real-world target. Accordingly, the eye tracking model and the accurate vehicle pose from the IMU can then be used together as inputs into a predictive model that utilizes the low latency IMU data to correct the model eye position, thereby bringing it closer to the actual instantaneous eye position. In one example, vehicle pose refers to the position and orientation of the vehicle along six degrees of freedom, with reference to its ‘zero’ state (e.g., no acceleration or velocity along or around any axis). In this way, the AR HUD system described herein provides low-latency eye position correction to improve the accuracy and efficacy of the user AR experience.

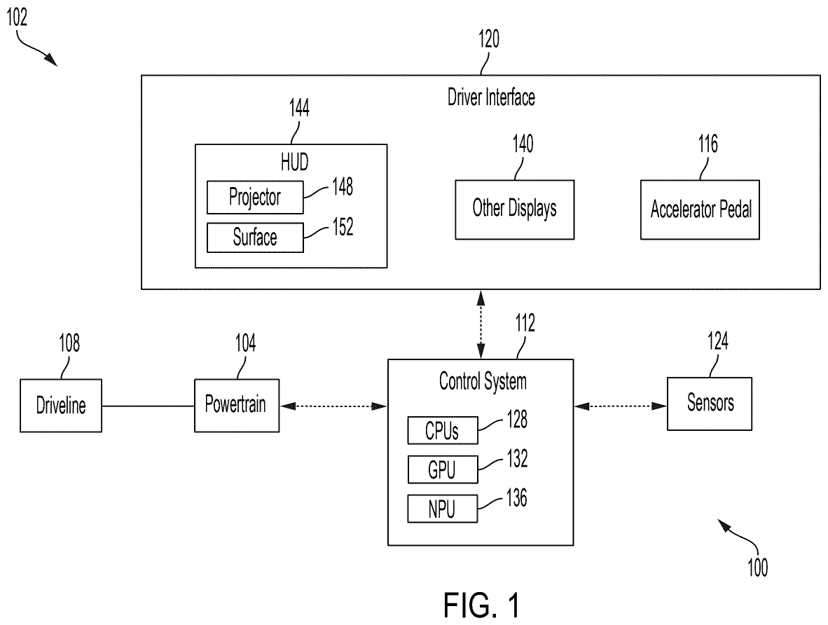

Referring now to FIG. 1, a functional block diagram of a vehicle 100 having an example AR HUD system 102 is illustrated according to the principles of the present application. The vehicle 100 generally comprises a powertrain 104 that is configured to generate and transfer torque to a driveline 108 for vehicle propulsion. Non-limiting examples of the components of the powertrain 104 include an internal combustion engine, one or more electric motors, and an automatic transmission.

A control system 112 controls operation of the vehicle 100, including primarily controlling the powertrain 104 to generate and transfer to the driveline 108 a desired amount of torque to satisfy a driver torque request. The driver torque request is received by the control system 112 from a driver interface 120, which could include an accelerator pedal 116 and any other suitable driver input/output systems. The control system 112 is also configured to communicate with a sensor system 124, as described herein in more detail. While a single control system 112 is shown, it will be understood that control system 112 may represent a plurality of separate control systems or separate controllers (e.g., one control system for the powertrain 104 and one for the sensor system 124).

In one exemplary implementation, the control system 112 includes a plurality of application-specific integrated circuits (ASICs), a plurality of central processing units (CPUs) 128, a graphical processing unit (GPU) 132, and/or a neural processing unit (NPU) 136. The control system 112 could include a plurality, for example, of electronic control units (ECUs) that each have their own CPU(s) 128 (an engine control module, a transmission control module, a hybrid control processor, etc.). The GPU 132 and the NPU 136, for example, could both be part of a same system-on-chip (SoC). The GPU 132 is configured to control graphical processing/rendering for human-machine interfaces (HMIs) or images displayed by one or more displays 140 (an infotainment unit, an in-dash or instrument panel cluster (IPC) display, etc.) of the driver interface 120. The NPU 136 is a separate processor from the GPU and other existing central processing units (CPUs) and the NPU 136 is configured to handle machine learning model execution (e.g., artificial intelligence, or AI processes). NPUs 136 are designed to operate with lower power and latency compared to other processors. The driver interface 120 further includes another display, a HUD 144. The HUD 144 includes a projector or projection system 148 and a surface 152 (e.g., a reflective portion of a surface of a curved windshield of the vehicle 100).

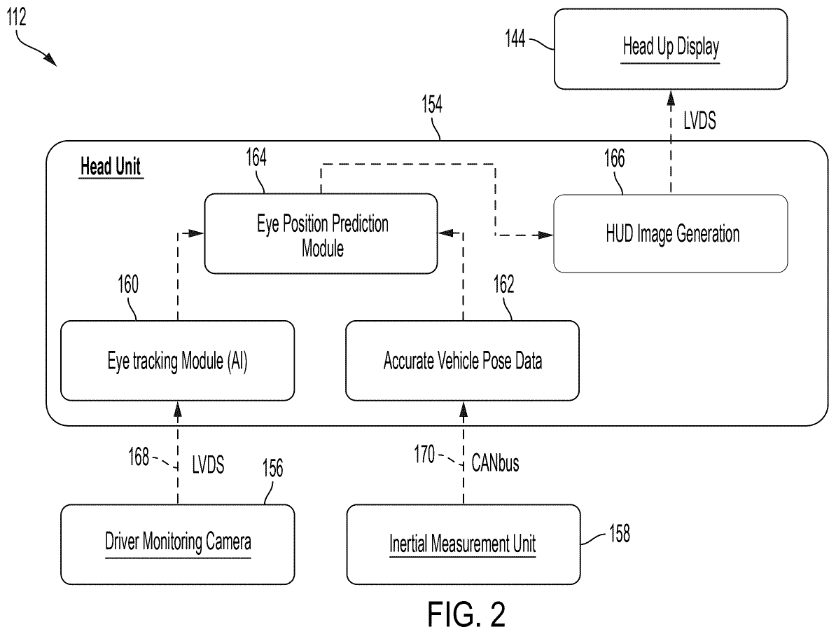

Referring now to FIG. 2, a functional block diagram of an example architecture for the control system 112 according to the principles of the present application is illustrated. In the example embodiment, the control system 112 includes a head unit 154 in signal communication with the HUD 144 and the sensor system 124, which includes a driver monitoring camera (DMC) 156 and an inertial measurement unit (IMU) 158.

The head unit 154 is a controller or electronic control unit that is the control center for the vehicle infotainment system. The head unit 154 is capable of receiving sensor data and calculating information such as vehicle pose and eye tracking prediction. In the example implementation, the head unit 154 generally includes an artificial intelligence (AI) eye tracking module 160, an accurate vehicle pose data module 162, an eye position prediction module 164, and a HUD image generator 166.

The AI eye tracking module 160 is configured to receive data from the DMC 156 via a low voltage differential signal (LVDS) 168. The DMC 156 is utilized to observe, record, and transmit specific user related features such as attentiveness, head position, eye position, gaze direction, etc. In one example, the DMC 156 is a cabin-interior camera configured to monitor a driver head position, a driver eye position, and a driver gaze vector (e.g., a direction the driver is looking) and provide one or more signals indicative thereof. In one example, the driver gaze vector is calculated based on a driver monitoring algorithm that utilizes input from the driver interior camera.

In one example, the LVDS 168 is a technical standard that specifies electrical characteristics of a differential, serial signaling standard. The LVDS 168 operates at low power and can run at very high speeds using inexpensive twisted-pair copper cables. The AI eye tracking module 160 is configured to model and predict driver eye tracking. In one example, the modeling is performed in five steps: collection, preprocessing, feature extraction, model training, and prediction. First, a facial detection model is trained on data representative of what the DMC 156 will see in an actual vehicle environment. This may be a large number of images of different faces, positioned at different points within the camera's field of view, with varying eye shapes, states of openness, gaze directions, etc. Next, the collected data is implemented into the model for the processing step. During this step, the model is trained to identify things such as regions of the face, locate and crop the areas specific to the eyes, signal noise removal, etc. Next, the trained AI model is then utilized to extract specific eye information including pupil position, reflection, eye shape, etc. Finally, the tracking model is then able to use this information to estimate the location and gaze direction. The AI eye tracking module 160 then sends this data to the eye position prediction module 164.

In the example embodiment, the IMU 158 is in signal communication with the accurate vehicle pose data module 162 via a CAN bus 170. The IMU 158 is configured to provide one or more signals indicative of inertial movements of vehicle 100 such as, for example, yaw rate, pitch rate, acceleration, etc. The accurate vehicle pose data module 162, also referred to as vehicle motion module 162, is configured to determine a motion (e.g., axial and angular accelerations) of the vehicle 100. For example, vehicle speed, acceleration, and yaw and pitch rates may be determined from IMU 158. The vehicle motion module 162 then sends vehicle motion data to the eye position prediction module 164.

In the example implementation, the eye position prediction module 164 is configured to improve the eye tracking estimation and prediction model of eye tracking module 160 through the integration of data received from the IMU 158. The IMU 158 is configured to provide motion data (e.g., acceleration, velocity, displacement) of the vehicle 100. Each vehicle is designed with a coordinate system with a singular origin. The coordinate (X, Y, Z) delta for the HUD/virtual image and eye ellipse position, with reference to that origin, is known. Additionally, the geometric relationship between the HUD/virtual image and eye ellipse is also known. The IMU coordinate data, in combination with the location of the eyes provided by the DMC 156, enables more accurate position by introducing a correction factor to the eye position based on the vehicle motion characteristics. With larger displacement and lower acceleration, a higher correction may be used, while with the inverse, a lower correction may be used. This also acts as a smoothing function, preventing a jittering HUD image as a result of constant correction for high frequency vibrations. The eye position prediction module 164 then sends this data to the HUD image generator 166.

In one example, the HUD image generator 166 is configured to perform a real-time rendering operation for HUD image generation to allow for dynamic rendering of the real-timer inputs being received from the eye position prediction module 164. Various rendering methods may be utilized such as for example, double buffering to prevent flicker or image tear with a front and back buffer operation, or temporal antialiasing to blend information from multiple frames, using past frames to smooth out aliasing effects (e.g., jagged edges of an image). The HUD image generator 166 then sends an image via LVDS 168 to the HUD 144, which utilizes projector 148 to display the image on surface 152.

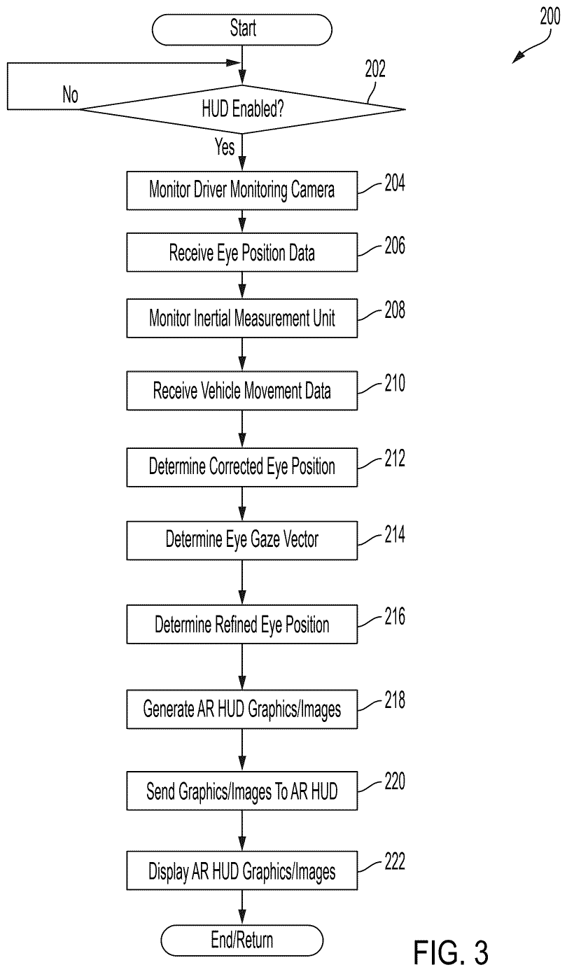

Referring now to FIG. 3, a flow diagram of an example control method 200 for an AR HUD system of a vehicle is illustrated in accordance with the principles of the present application. While the vehicle 100 and its components are specifically discussed for descriptive/illustrative purposes, it will be appreciated that the method 200 could be applicable to any suitable vehicle. The method begins at 202 where the control system 112 or other controller such as head unit 154 (“control”) determines whether the HUD 144 is enabled or activated. If no, control returns to 202. If yes, control proceeds to step 204.

At 204, control monitors the DMC 156, for example, to detect and track driver eye movement. At 206, control receives eye position data from the DMC 156. At 208, control monitors the IMU 158, for example, to measure acceleration, tilt, and rotational movement of the vehicle 100. At 210, the vehicle motion module 162 receives vehicle movement data from the IMU 158. At 212, control utilizes the eye position prediction module 164, which includes one or more algorithms to combine the eye position data and the vehicle movement data, to thereby determine corrected eye position data. In one example, corrected eye position refers to an accurate eye position with relation to the vehicle coordinate system.

At 214, control determines/estimates an eye gaze vector direction based on the corrected eye position data. At 216, control determines a refined eye position based on the eye gaze vector direction, implemented Kalman filters, and predictive modeling. In one example, refined eye position refers to an eye position that has been predicted by the IMU enhanced prediction model. At 218, control utilizes the HUD image generator 166 to render graphics/images based on the refined eye position data. At 220, control sends the rendered graphics/images to the AR HUD 144 via LVDS 168. At 222, control utilizes the AR HUD 144 to display the graphics/images on the windshield surface 152. The method 200 then ends or returns to 202 for one or more cycles.

It will be appreciated that the terms “controller” or “control system” or “module” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

1. A heads-up display (HUD) system for a vehicle, the HUD system comprising:
a HUD configured to project augmented reality (AR) graphics on a surface of the vehicle in an active field of view of the driver;
a driver monitoring camera (DMC) configured to monitor a driver eye position and gaze direction;
an inertial measurement unit (IMU) configured to measure motion of the vehicle;
a control system including a computing device having one or more processors and a non-transitory computer-readable storage medium having a plurality of instructions stored thereon, which, when executed by the one or more processors, cause the one or more processors to perform operations comprising:
receiving driver eye position and gaze direction data from the DMC;
receiving vehicle motion data from the IMU;
generating AR HUD graphics based on the driver eye position and gaze direction data and the vehicle motion data; and
displaying, by the HUD, the generated AR HUD graphics on the vehicle surface; and
a CAN bus connection between the IMU and the control system, wherein data from the IMU is received at a frequency no slower than 30 Hz.

2. The HUD system of claim 1, wherein the generated AR HUD graphics provide real-time corrections to AR HUD graphics based on real-time vehicle movement, driver head movement, and driver eye movement such that the displayed AR HUD graphics are accurately displayed in an intended position with respect to the driver's perspective of a real-world scene.

3. The HUD system of claim 1, wherein the vehicle motion measured by the IMU includes axial and angular accelerations of the vehicle.

4. The HUD system of claim 1, further comprising a low voltage differential signal (LVDS) connection between the DMC and the control system.

5. The HUD system of claim 8, further comprising a CAN bus connection between the IMU and the control system, wherein data from the IMU is received at a frequency no slower than 30 Hz.

6. The HUD system of claim 5, wherein data from the IMU is received at a frequency no slower than 100 Hz.

7. The HUD system of claim 1, wherein the control system processes data from the DMC using Convolutional Neural Networks (CNNs) and/or Recurrent Neural Networks (RNNs).

8. A heads-up display (HUD) system for a vehicle, the HUD system comprising:
a HUD configured to project augmented reality (AR) graphics on a surface of the vehicle in an active field of view of the driver;
a driver monitoring camera (DMC) configured to monitor a driver eye position and gaze direction;
an inertial measurement unit (IMU) configured to measure motion of the vehicle; and
a control system including a computing device having one or more processors and a non-transitory computer-readable storage medium having a plurality of instructions stored thereon, which, when executed by the one or more processors, cause the one or more processors to perform operations comprising:
receiving driver eye position and gaze direction data from the DMC;
receiving vehicle motion data from the IMU;
generating AR HUD graphics based on the driver eye position and gaze direction data and the vehicle motion data; and
displaying, by the HUD, the generated AR HUD graphics on the vehicle surface,
wherein the control system further processes data from the DMC utilizing Kalman filters to smooth noisy image data and predict an accurate eye gaze position.

9. The HUD system of claim 1, wherein the surface is a windshield of the vehicle.

10. The HUD system of claim 1, wherein the DMC is infrared (IR) based.

11. A computer-implemented method for controlling a vehicle heads-up display (HUD) system having a HUD configured to project augmented reality (AR) graphics on a surface of the vehicle in an active field of view of the driver, a driver monitoring camera (DMC) configured to monitor a driver eye position and gaze direction, and an inertial measurement unit (IMU) configured to measure motion of the vehicle, the method comprising:
receiving, at a computing device having one or more processors, driver eye position and gaze direction data from the DMC;
receiving, at the computing device, vehicle motion data from the IMU;
generating, by the computing device, AR HUD graphics based on the driver eye position and gaze direction data and the vehicle motion data; and
displaying, by the HUD, the generated AR HUD graphics on the vehicle surface,
wherein the HUD system further includes a CAN bus connection between the IMU and the control system, wherein data from the IMU is received at a frequency no slower than 30 Hz.

12. The method of claim 11, wherein the generated AR HUD graphics provide real-time corrections to AR HUD graphics based on real-time vehicle movement, driver head movement, and driver eye movement such that the displayed AR HUD graphics are accurately displayed in an intended position with respect to the driver's perspective of a real-world scene.

13. The method of claim 11, wherein the vehicle motion measured by the IMU includes axial and angular accelerations of the vehicle.

14. The method of claim 11, wherein the HUD system further includes a low voltage differential signal (LVDS) connection between the DMC and the control system.

15. (canceled)

16. The method of claim 11, wherein data from the IMU is received at a frequency no slower than 100 Hz.

17. The method of claim 11, further comprising:
processing, by the computing device, data from the DMC using Convolutional Neural Networks (CNNs) and/or Recurrent Neural Networks (RNNs).

18. The method of claim 17, further comprising:
processing, by the computing device, data from the DMC using Kalman filters to smooth noisy image data and predict an accurate eye gaze position.

19. The method of claim 11, wherein the surface is a windshield of the vehicle.

20. The method of claim 11, wherein the DMC is infrared (IR) based.
